(19) United States
(12) Patent Application Publication
(10) Pub. No.: US 2024/0251257 A1
(43) Pub. Date: Jul. 25, 2024

(54) METHOD AND APPARATUS FOR IMPROVING MOBILITY MANAGEMENT PERFORMANCE TO REDUCE UNNECESSARY HANDOVER OCCURRENCES

(71) Applicant: ELECTRONICS AND TELECOMMUNICATIONS RESEARCH INSTITUTE, Daejeon (KR)

(72) Inventors: Hyun Seo PARK, Daejeon (KR); Yong Jin KWON, Daejeon (KR); Yun Joo KIM, Daejeon (KR); Han Jun PARK, Daejeon (KR); Jung Bo SON, Daejeon (KR); An Seok LEE, Daejeon (KR); Yu Ro LEE, Daejeon (KR); Sung Cheol CHANG, Daejeon (KR); Heesoo LEE, Daejeon (KR)

(73) Assignee: ELECTRONICS AND TELECOMMUNICATIONS RESEARCH INSTITUTE, Daejeon (KR)

(21) Appl. No.: 18/542,253

(22) Filed: Dec. 15, 2023

(30) Foreign Application Priority Data
Dec. 16, 2022 (KR) 10-2022-0176743

(51) Int. Cl. H04W 24/02; H04W 16/22; H04W 24/10

(52) U.S. Cl. CPC H04W 24/02; H04W 16/22; H04W 24/10

(57) ABSTRACT

Disclosed are a method and an apparatus for improving mobility management performance by reducing unnecessary handovers in a communication system. a method of a terminal may comprise: receiving cell prediction configuration information; generating measurement results by performing measurements on a serving cell and neighbor cell(s) based on signal strength measurement configuration information; and generating a result of predicting a best cell by performing best cell prediction based on the measurement results.

### CROSS-REFERENCE TO RELATED APPLICATIONS

This application claims priority to Korean Patent Application No. 10-2022-0176743, filed on Dec. 16, 2022, with the Korean Intellectual Property Office (KIPO), the entire contents of which are hereby incorporated by reference.

### BACKGROUND

### 1. Technical Field

The present disclosure relates to a handover technique in a communication system, and more particularly, to a technique for improving mobility management performance by reducing unnecessary handover occurrences.

### 2. Related Art

When a handover occurs due to a terminal moving in a new radio (NR) or long-term evolution (LTE) system, an interruption time during which data cannot be received may occur while a connection with a source cell is disconnected and a connection with a target cell is established. In order to reduce the interruption time, a dual active protocol stack (DAPS) handover technique, which maintains connection with the source cell during handover and disconnects from the source cell after completing the handover to the target cell, has been adopted in the NR and LTE. The DAPS handover technique satisfies 0 ms interruption time by simultaneously receiving data from the source cell and target cell during the handover.

However, in the DAPS handover, the terminal should use a DAPS packet data convergence protocol (PDCP) entity and radio link control (RLC)/medium access control (MAC)/physical (PHY) entities for each of the two cells in order to simultaneously receive and process data from the source cell and target cell, and this may cause a problem that terminal complexity increases. Techniques to reduce an interruption time may be required in the communication system.

### SUMMARY

The present disclosure for achieving the above-described objective is directed to providing a method and a control apparatus for improving mobility management by reducing unnecessary handover occurrences in a communication system.

A method of a terminal, according to exemplary embodiments of the present disclosure for achieving the above-described objective, may comprise: receiving cell prediction configuration information; generating measurement results by performing measurements on a serving cell and neighbor cell(s) based on signal strength measurement configuration information; generating a result of predicting a best cell by performing best cell prediction based on the measurement results; determining a target cell that satisfies a cell change condition based on the measurement results; identifying whether to change the serving cell of the terminal to the target cell based on the result of predicting the best cell; and in response to identifying that the serving cell is changed to the target cell, performing a procedure to change the serving cell of the terminal to the target cell.

According to the present disclosure, occurrences of unnecessary handovers, such as a ping-pong handover or a handover having a short cell dwell time, can be reduced by utilizing predicted information on a cell with the best signal strength during a handover or cell switching process. If a time during which a specific cell is maintained as the best cell is predicted to be shorter than a specific time based on the predicted information on the cell with the best signal strength, execution of the handover or cell switching to the corresponding cell can be prevented. Furthermore, the present disclosure provides a method for reducing occurrences of unnecessary ping-pong handovers by utilizing information regarding previous handover(s) or cell switching(s). During a handover or cell switching process, a case where a new target cell is connected and then an attempt is made to hand over back to a source cell of a previous handover can be classified into a ping-pong handover or a non-ping-pong handover. When classified as a ping-pong handover, a probability of the ping-pong handover can be reduced by applying a signal strength offset to the source cell of the previous handover. Accordingly, unnecessary handover occurrences can be reduced, and signaling overhead can be minimized. In addition, improvement in the handover or cell switching performance can be achieved by reducing unnecessary data transmission and recovery procedures.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a sequence chart for describing an LTM procedure according to an exemplary embodiment of the present disclosure.

FIG. 4 is a conceptual diagram for describing an exemplary embodiment of a handover execution time according to the present disclosure.

FIG. 5 is a sequence chart for describing a method for measuring and reporting received signal strengths according to an exemplary embodiment of the present disclosure.

FIG. 6 is a sequence chart for describing a prediction configuration signaling procedure for a best cell prediction method according to an exemplary embodiment of the present disclosure.

FIG. 7 is a flowchart for describing a best cell prediction procedure of a terminal according to an exemplary embodiment of the present disclosure.

FIG. 8 is a sequence chart for describing a best cell prediction model feedback procedure according to a first exemplary embodiment of the present disclosure.

FIG. 9 is a sequence chart for describing a best cell prediction model feedback procedure according to a second exemplary embodiment of the present disclosure.

FIG. 10 is a sequence chart for describing an exemplary embodiment of a ping-pong handover reduction signaling procedure using previous handover information according to the present disclosure.

FIG. 11 is a flowchart for describing an exemplary embodiment of a procedure of a terminal that reduces occurrences of ping-pong handover using previous handover information according to the present disclosure.

FIG. 12 is a flowchart for describing an embodiment exemplary of a method for reducing occurrence of ping-pong handovers using previous handover information according to the present disclosure.

FIG. 13 is a block diagram illustrating an exemplary embodiment of a mobility management performance enhancing apparatus according to the present disclosure.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and redundant descriptions for the same elements are omitted.

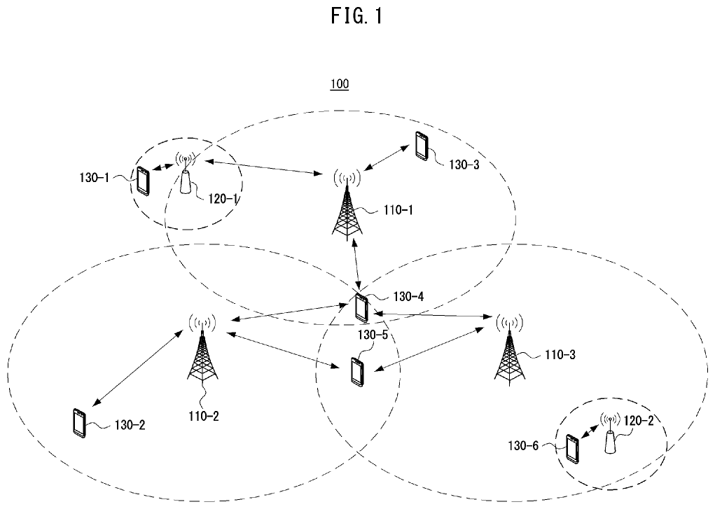

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g. long term evolution (LTE), LTE-advanced (LTE-A)), 5th generation (5G) communication (e.g. new radio (NR)), or the like. The 4G communication may be performed in a frequency band of 6 gigahertz (GHz) or below, and the 5G communication may be performed in a frequency band of 6 GHz or above as well as the frequency band of 6 GHz or below.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

In addition, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

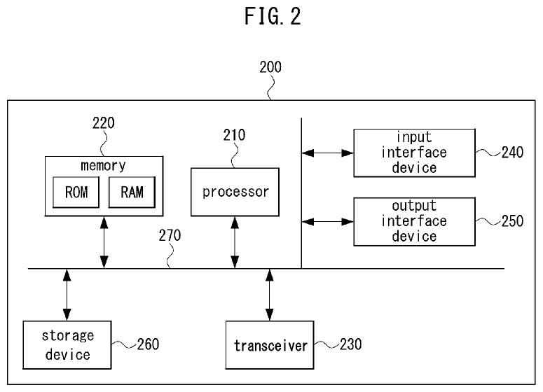

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a radio remote head (RRH), a transmission point (TP), a transmission and reception point (TRP), an eNB, a gNB, or the like.

Here, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IoT) device, a mounted apparatus (e.g. a mounted module/device/terminal or an on-board device/terminal, etc.), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

Meanwhile, when a handover (HO) occurs due to a terminal moving in the NR or LTE system, an interruption time during which data cannot be received may occur while a connection with a source cell is disconnected and a connection with a target cell is established. In order to reduce the interruption time, a dual active protocol stack (DAPS) handover technique, which maintains connection with the source cell during handover and disconnects from the source cell after completing the handover to the target cell, has been adopted in the NR and LTE. The DAPS handover technique satisfies 0 ms interruption time by simultaneously receiving data from the source cell and target cell during the handover. However, in the DAPS handover, the terminal should use a DAPS PDCP entity and RLC/MAC/PHY entities for each of the two cells in order to simultaneously receive and process data from the source cell and target cell, and this may cause a problem that terminal complexity increases.

An L1/2-triggered mobility (LTM) technique, which reduces an interruption time but also reduces terminal complexity by enabling data reception from either the source cell or the target cell at one time, has been determined to be introduced in the NR system. The LTM technique prepares candidate cells for the terminal in advance, determines a candidate cell to be switched to a target cell based on layer 1 (L1) measurement results, and notifies the terminal of this. Thereafter, the terminal applies configuration information of the candidate cells, acquires uplink synchronization by performing a random access procedure to the candidate cell determined as the target cell, and connects to the target cell to quickly initiate data transmission.

In the LTM technique, since the candidate cell to be switched to the target cell is determined based on the L1 measurement results, in normal cases, cell switching to a cell with better signal strength may frequently occur. In particular, a ping-pong handover, in which cell switching is performed from the source cell to the target cell and then from the target cell back to the source cell shortly after, may occur frequently. The ping-pong handover has a problem of deteriorating handover performance due to unnecessary data transfer and recovery procedures as well as signaling overhead.

### L1/L2-Triggered Mobility Method

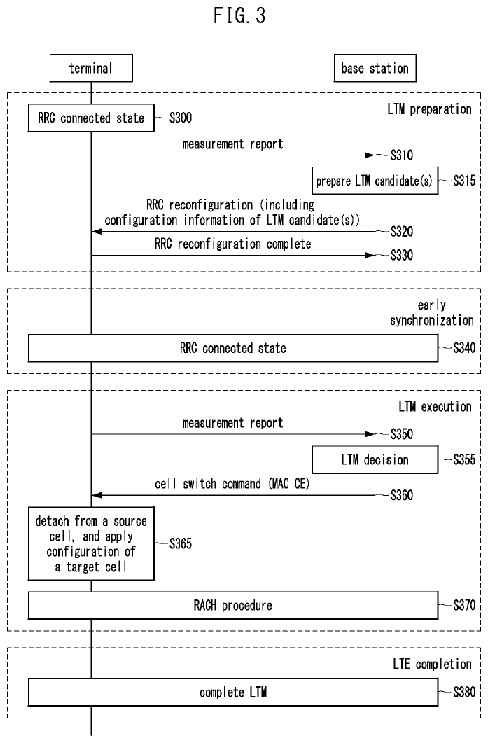

FIG. 3 is a sequence chart for describing an LTM procedure according to an exemplary embodiment of the present disclosure.

Referring to FIG. 3, an LTM procedure may include an LTM preparation process, an early synchronization process, an LTM execution process, and an LTM completion process. A radio resource control (RRC) connection between a base station and a terminal may be assumed to be a connected state (i.e. RRC connected state).

In the LTM preparation process of the LTM procedure, steps S300 to S330 may be performed.

In steps S300 to S330, the terminal may be in the RRC connected state with the base station (S300). The terminal may report signal strength measurement results for a serving cell and neighbor cell(s) by transmitting a measurement report message (e.g. MeasurementReport message) to the base station (S310). The base station may prepare LTM candidate cell(s) based on the reported signal strength measurement results (S315). The base station may transmit configuration information of the prepared LTM candidate cell(s) by transmitting an RRC reconfiguration message (e.g. RRCReconfiguration message) to the terminal. The terminal may receive the RRC reconfiguration message and store the configuration information of the LTM candidate cell(s) (S320). In addition, the terminal may transmit an RRC reconfiguration complete message (e.g. RRCReconfigurationComplete message) to the base station in response to the RRC reconfiguration message (S330).

In the early synchronization process of the LTM procedure, the terminal may acquire downlink (DL) synchronization with the LTM candidate cell(s) before receiving an LTM cell switch command message to reduce an interruption time. In addition, the terminal may acquire uplink (UL) synchronization (S340).

In the LTM execution process of the LTM procedure, steps S350 to S370 may be performed.

In steps S350 to S370, the terminal may perform signal strength measurement on the LTM candidate cell(s) and transmit an L1 signal strength measurement result report message to the base station. The base station may receive the L1 signal strength measurement result report message from the terminal (S350). The base station may determine an LTM candidate cell to be changed to a target cell based on the L1 signal strength measurement results of the terminal received in step S350 (S355). The base station may transmit a cell switch command to the terminal through a MAC control element (CE) (S360). Then, the terminal may disconnect from a source cell and apply the configuration information of the LTM candidate cell determined as the target cell (S365). The terminal may attempt to access the candidate cell determined as the target cell. If UL synchronization is not valid, the terminal may acquire UL synchronization by performing a random access procedure (S370).

In the LTM completion process of the LTM procedure, the terminal may notify a target base station that connection to the target cell has been completed normally. The base station may initiate data transmission to the terminal (S380).

### Pine-Pong Handover Reduction Method Using L1 Filter and TTT

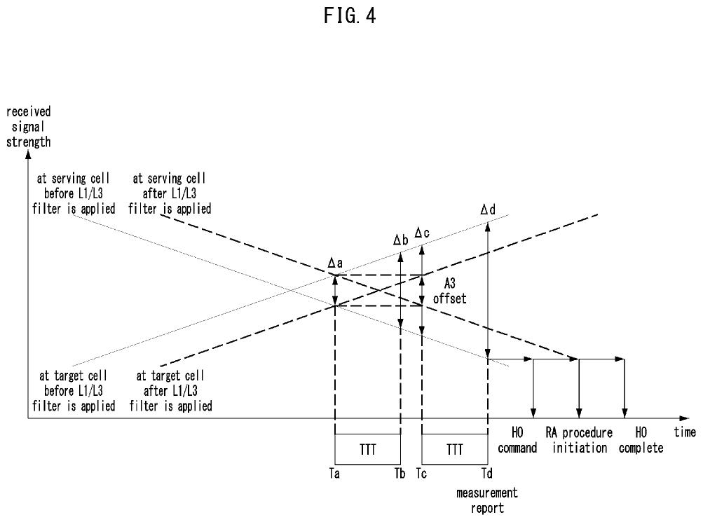

FIG. 4 is a conceptual diagram for describing an exemplary embodiment of a handover execution time according to the present disclosure.

Referring to FIG. 4, in a communication system, a terminal may measure received signal strengths of a serving base station operating a serving cell and neighbor base station(s) including a target base station operating a target cell. In general, variation in received signal strength in an actual wireless channel may be large due to effects such as fading. Therefore, the terminal may apply an L1 filter to obtain an average value over a certain period of time and use it as the received signal strength. For example, a difference Δa between a received signal strength of the target base station and a received signal strength of the serving base station at a time Ta may be greater than or equal to a handover margin, a difference Δb between a received signal strength of the target base station and a received signal strength of the serving base station at a time Tb may be greater than or equal to the handover margin, and a difference between Tb and Ta may exceed a trigger time (IT).

In order to reduce ping-pong handovers and ensure reliable handover decisions in the presence of fading effects, the terminal may further apply a layer 3 (L3) filter to the result of applying the L1 filter. The terminal may calculate an exponentially weighted average by multiplying the result of L1 filtering with a weight based on L3 filtering, and use it as a final received signal strength. In the above-described manner, the terminal can make handover decisions reliably from fading effects while reducing ping-pong.

In this case, a difference Δc between a received signal strength of the target base station and a received signal strength of the serving base station at a time Tc may be greater than or equal to the handover margin, a difference Δd between a received signal strength of the target base station and a received signal strength of the serving base station at a time Td may be greater than or equal to the handover margin, and a difference between Td and Tc may exceed the trigger time. When only the L1 filtering is applied, Ta may be a handover time based on an A3 offset. However, the handover time may be delayed to Tc when applying the L3 filtering. Further, if the trigger time is applied, the handover time may be further delayed to Td. The L1 filtering, L3 filtering, and trigger time can enable a handover to be determined reliably. However, a probability of handover failure may increase due to the delay in the handover time which is caused by the L1 filtering, L3 filtering, and trigger time.

Meanwhile, the terminal may transmit a measurement report message to the serving base station at the time Td. The serving base station may receive the measurement report message from the terminal. The serving base station may determine a handover of the terminal based on the received signal strengths of the serving base station and neighbor base station(s) included in the measurement report message. In this case, the serving base station may transmit a handover preparation message to a target base station for the terminal to proceed with the handover. The target base station may receive the handover preparation message from the serving base station. The target base station may decide whether to approve the handover of the terminal based on the handover preparation message. If the target base station approves the handover of the terminal, the target base station may transmit a handover preparation response message to the serving base station.

The serving base station may receive the handover preparation response message from the target base station. The serving base station may transmit a handover command message instructing the handover indicated by the handover preparation response message to the terminal. At this time, a state of a radio link between the serving base station and the terminal may be poor. As a result, a probability of handover failure may increase. Here, the handover command message may be included in an RRC reconfiguration message transmitted from the serving base station to the terminal. The terminal may receive the handover command message from the serving base station. After receiving the handover command message, the terminal may acquire DL synchronization with the target base station, and then transmit a random access preamble to the target base station to initiate a random access procedure. The terminal may acquire UL synchronization through the random access procedure, and then complete the handover by transmitting a handover complete message to the target base station. Here, the random access procedure may be performed when a radio link with the target base station is in a good state. As a result, a probability of error occurrence in the random access procedure may be low. In addition, the handover complete message may also be transmitted when the radio link with the target base station is in a good state. As a result, a probability of error occurrence in transmission of the handover complete message may be low.

As shown in FIG. 3, in the LTM technique, the base station may determine the LTM candidate cell to be changed to the target cell based on the L1 measurement results of the terminal. If the L1 measurement results are used without special processing, the fading effects may be directly reflected in the cell switching. This may cause frequent cell switching, and communication quality may be significantly degraded due to an interruption time that occurs during the cell switching process.

In the LTM technique, similarly to the existing L3-based handover algorithm, the occurrence of unnecessary cell switching can be reduced by applying the L1 filter or TTT to the L1 measurement results of the terminal. However, as shown in FIG. 4, when the L1 filter or TTT is applied to the L1 measurement results, the cell switching may be performed later than a time required based on actual signal strengths. Accordingly, overall performance in terms of transmission speed may be significantly reduced.

### Existing Signal Strength Measurement and Reporting Methods

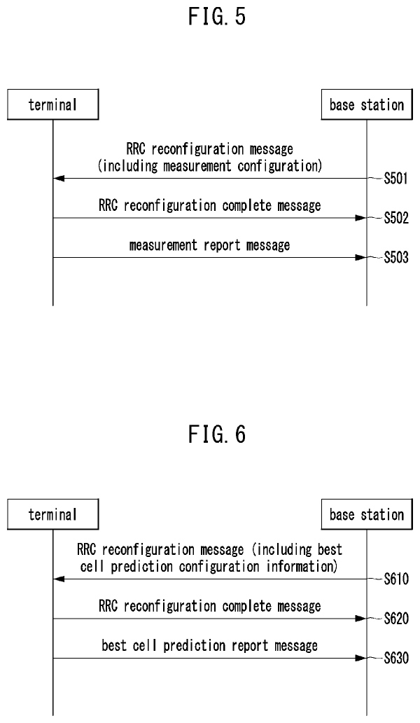

FIG. 5 is a sequence chart for describing a method for measuring and reporting received signal strengths according to an exemplary embodiment of the present disclosure.

Referring to FIG. 5, the base station may generate signal strength measurement configuration information according to capability of the terminal, network configuration information, or the like. In addition, the base station may configure the signal strength measurement configuration information as measurement configuration information element (abbreviated as measConfig IE), and transmit it to the terminal by including it in an RRC reconfiguration message (S510). Accordingly, the terminal may receive the RRC reconfiguration message including the measurement configuration IE from the base station. The terminal may perform signal strength measurement according to the measurement configuration IE of the signal strength measurement configuration information. Then, the terminal may transmit an RRC reconfiguration complete message to the base station in response to the RRC reconfiguration message (S502). Then, the base station may receive the RRC reconfiguration complete message from the terminal.

The measurement configuration IE may be configured as shown in Table 1 below. In the measurement configuration IE, measObjectToRemoveList may provide a list of measurement objects to be removed. In the measurement configuration IE, measObjectToAddModList may provide a list of measurement objects to be added or modified. In the measurement configuration IE, reportConfigToRemoveList may provide a list of measurement reporting targets to be removed. In the measurement configuration IE, reportConfigToAddModList may provide a list of measurement reporting targets to be added or modified. In the measurement configuration IE, quantityConfig may provide L3 filter configuration information. In the measurement configuration IEs, measIdToRemoveList may provide a list of identifiers to be deleted from a measurement identifier list of measurement objects. In the measurement configuration IE, measIdToAddModList may provide a list of identifiers to be added or modified to the measurement identifier list of measurement objects. In the measurement configuration IE, s-MeasureConfig may be a configuration that prevents measurement on neighbor cells from being performed when the received signal strength of the serving cell is equal to or greater than a specific threshold.

TABLE 1
-- ASN1START
-- TAG-MEASCONFIG-START
MeasConfig ::= SEQUENCE {

| measObjectToRemoveList | MeasObjectToRemoveList | OPTIONAL, -- Need N |
|---|---|---|
| measObjectToAddModList | MeasObjectToAddModList | OPTIONAL, -- Need N |
| reportConfigToRemoveList | ReportConfigToRemoveList | OPTIONAL, -- Need N |
| reportConfigToAddModList | ReportConfigToAddModList | OPTIONAL, -- Need N |
| measIdToRemoveList | MeasIdToRemoveList | OPTIONAL, -- Need N |
| measIdToAddModList | MeasIdToAddModList | OPTIONAL, -- Need N |
| s-MeasureConfig | CHOICE { | |
| ssb-RSRP | RSRP-Range, | |
| csi-RSRP | RSRP-Range | |
| } | | OPTIONAL, -- Need M |
| quantityConfig | QuantityConfig | OPTIONAL, -- Need M |
| measGapConfig | MeasGapConfig | OPTIONAL, -- Need M |
| measGapSharingConfig | MeasGapSharingConfig | OPTIONAL, -- Need M |

```
  ...,
  [[
```

| | | |
|---|---|---|
| interFrequencyConfig-NoGap-r16 | ENUMERATED {true} | OPTIONAL -- Need R |

]],
}

| | |
|---|---|
| MeasObjectToRemoveList ::= | SEQUENCE (SIZE (1..maxNrofObjectId)) OF MeasObjectId |
| MeasIdToRemoveList ::= | SEQUENCE (SIZE (1..maxNrofMeasId)) OF MeasId |
| ReportConfigToRemoveList ::= | SEQUENCE (SIZE (1..maxReportConfigId)) OF ReportConfigId |

-- TAG-MEASCONFIG-STOP
-- ASN1STOP

Meanwhile, the terminal may measure the received signal strengths (i.e. reference signal received power (RSRP), reference signal received quality (RSRQ), or signal to interference-plus-noise ratio (SINR)) of neighbor base stations according to the measurement configuration IE of the signal strength measurement configuration information. In addition, the terminal may report signal strength measurement results including the measured received signal strengths of the neighbor base stations to the base station through a measurement report message periodically according to a measurement report configuration (S503). Alternatively, the terminal may report the signal strength measurement results including the measured received signal strengths of the neighbor base stations to the base station through a measurement report message when the received signal strength(s) of the neighbor base station(s) satisfy a specific event according to the measurement report configuration. The measurement report message may be configured as shown in Table 2 below.

TABLE 2
-- ASN1START
-- TAG-MEASUREMENTREPORT-START

| | |
|---|---|
| MeasurementReport ::= | SEQUENCE { |
| criticalExtensions | CHOICE { |
| measurementReport | MeasurementReport-IEs, |
| criticalExtensionsFuture | SEQUENCE { } |

}
}

| MeasurementReport-IEs ::= | SEQUENCE { | |
|---|---|---|
| measResults | MeasResults, | |
| lateNonCriticalExtension | OCTET STRING | OPTIONAL, |
| nonCriticalExtension | SEQUENCE{ } | OPTIONAL |

}
-- TAG-MEASUREMENTREPORT-STOP
-- ASN1STOP

The base station may receive the measurement report message from the terminal. Here, the measurement report message may include measurement result IE (abbreviated as measResults IE) which correspond to the signal strength measurement results. The measurement result IE may be as shown in Table 3 below.

TABLE 3
-- ASN1START
-- TAG-MEASRESULTS-START

| | |
|---|---|
| MeasResults ::= | SEQUENCE { |
| measId | MeasId, |
| measResultServingMOList | MeasResultServMOList, |
| measResultNeighCells | CHOICE { |
| measResultListNR | MeasResultListNR, |

...,

| | |
|---|---|
| measResultListEUTRA | MeasResultListEUTRA, |
| measResultListUTRA-FDD-r16 | MeasResultListUTRA-FDD-r16, |
| sl-MeasResultsCandRelay-r17 | SL-MeasResultsRelay-r17 |

| | |
|---|---|
| } | OPTIONAL, |

```
  ...,
  [[
```

| | |
|---|---|
| measResultServFreqListEUTRA-SCG | MeasResultServFreqListEUTRA-SCG |
| OPTIONAL, | MeasResultServFreqListNR-SCG |

measResultServFreqListNR-SCG
OPTIONAL,

| | | |
|---|---|---|
| measResultSFTD-EUTRA | MeasResultSFTD-EUTRA | OPTIONAL, |
| measResultSFTD-NR | MeasResultCellSFTD-NR | OPTIONAL |

```
  ]],
  [[
```

| | | |
|---|---|---|
| measResultCellListSFTD-NR | MeasResultCellListSFTD-NR | OPTIONAL |

```
  ]],
  [[
```

| | | |
|---|---|---|
| measResultForRSSI-r16 | MeasResultForRSSI-r16 | OPTIONAL, |
| locationInfo-r16 | LocationInfo-r16 | OPTIONAL, |

| | |
|---|---|
| ul-PDCP-DelayValueResultList-r16 | UL-PDCP-DelayValueResultList-r16 |

OPTIONAL,

| | | |
|---|---|---|
| measResultsSL-r16 | MeasResultsSL-r16 | OPTIONAL, |
| measResultCLI-r16 | MeasResultCLI-r16 | OPTIONAL |

```
  ]],
  [[
```

| | | |
|---|---|---|
| measResultRxTxTimeDiff-r17 | MeasResultRxTxTimeDiff-r17 | OPTIONAL, |
| sl-MeasResultServingRelay-r17 | SL-MeasResultRelay-r17 | OPTIONAL, |

| | |
|---|---|
| ul-PDCP-ExcessDelayResultList-r17 | UL-PDCP-ExcessDelayResultList-r17 |

OPTIONAL

| | | |
|---|---|---|
| coarseLocationInfo-r17 | OCTET STRING | OPTIONAL |

]]
}

Meanwhile, a terminal mobility prediction technique may predict received signal strength measurement values at the terminal. The terminal mobility prediction technique may aim to determine an optimal target cell in advance by predicting terminal mobility based on the predicted received signal strength measurement values at the terminal. The terminal mobility prediction technique may execute an artificial intelligence (AI) algorithm and/or machine learning (ML) algorithm to predict the received signal strength measurement values at the terminal. In addition, the terminal mobility prediction technique may executes an AI algorithm and/or ML algorithm to predict terminal mobility based on the predicted received signal strength measurement value at the terminal and determine an optimal target cell in advance. To this end, the terminal mobility prediction technique may consider an option of configuring model training or model inference.

Here, AI may be a field of computer engineering and information technology that studies methods to enable computers to perform thinking, learning, and self-development tasks that are typically associated with human intelligence, achieved by enabling computers to mimic human intelligent behavior. ML, on the other hand, may be a subset of AI, involving a field of study that grants computers the ability to learn without explicit programming. Specifically, ML can be described as a technology capable of learning from empirical data, making predictions, and researching and constructing systems and algorithms to enhance their own performance. Unlike executing strictly fixed, static program instructions, ML algorithms can construct specific models to make predictions or decisions based on input data.

A terminal-based terminal mobility prediction technique can utilize more data without problems such as privacy than a base station-based terminal mobility prediction technique. Therefore, the terminal mobility prediction technique can achieve better performance when designed based on the terminal than when designed based on the base station. In contrast, the base station may have more information, such as cell deployment, that enables more accurate mobility prediction than the terminal. Therefore, better performance can be achieved when model training is based on the base station than when it is based on the terminal.

### Methods for Reducing Unnecessary Handovers

If prediction information on a cell with the best signal strength is used during the handover or cell switching process, occurrence of unnecessary handovers such as ping-pong handovers may be reduced. During a handover or cell switching process, if a dwell time in a specific cell is short, a ratio of an interruption time may increase, leading to a significant deterioration in communication quality. If a time during which a specific cell is maintained as the best cell is predicted to be shorter than a specific time using the prediction information, handover or cell switching to the specific cell may be prevented.

As one method, the base station may receive a signal strength measurement result report and a best cell prediction result report from the terminal. The base station may determine a handover of the terminal based on the received signal strength measurement result report. When the base station determines the handover of the terminal, the base station may check whether a time during which a specific cell is maintained as the best cell is predicted to be shorter than a specific time based on the best cell prediction result report. If the time during which the specific cell is maintained as the best cell is predicted to be shorter than the specific time, the base station may not perform a handover or cell switching to the specific cell.

As another method, the base station may receive a signal strength measurement result report and a best cell prediction result report from the terminal. The base station may configure the terminal not to perform triggered reporting of signal strength measurement results based on the received best cell prediction result of the terminal.

As another method, a handover, cell switching, or cell addition/change (e.g. conditional handover, conditional cell addition/change, and terminal-based LTM cell switching) may be determined by the terminal. When the terminal determines a handover, cell switching, or cell addition/change, the handover or cell switching may be prevented from being performed based on the best cell prediction result.

As another method, with respect to a cell (hereinafter referred to as ‘first cell’) that satisfies a handover, cell switching, or cell addition/change condition, whether an execution condition of a handover or cell switching to the first cell is satisfied may be determined based on the best cell prediction result. If it is determined that the execution condition is satisfied, the handover or cell switching to the first cell may be executed. If it is determined that the execution condition is not satisfied, the handover or cell switching to the first cell may not be executed. Here, if a time during which the first cell is maintained as the best cell is predicted to be shorter than a specific time, it may be determined that the execution condition is not satisfied. If not, it may be determined that the execution condition is satisfied.

### Best Cell Prediction Configuration Signaling Procedure

The prediction technique for a cell with the best signal strength may predict cells to have the best signal strength in the future by utilizing signal strength measurement results and location information that can be used to predict a mobility of the terminal. That is, the prediction technique aims to predict the cells to have the best signal strength in the future by predicting the mobility of the terminal based on the signal strength measurement results and location measurement results of the terminal. The following methods may be considered for terminal mobility prediction.

As one method, an option in which ML model training and model inference are performed in the terminal may be considered.

As another method, an option in which ML model training and model inference are performed at the base station and terminal as being separated may be considered. For example, ML model training may be performed at the base station, and model inference may be performed at the terminal. Since the base station has more information such as cell deployment that enables more accurate mobility prediction than the terminal, ML model training at the base station may achieve better performance.

FIG. 6 is a sequence chart for describing a prediction configuration signaling procedure for a best cell prediction method according to an exemplary embodiment of the present disclosure.

Referring to FIG. 6, a base station may configure best cell prediction configuration information for a terminal capable of performing best cell prediction according to capability of the terminal, network configuration information, or the like as needed. The base station may determine best cell prediction configuration information suitable for the terminal. The base station may transmit an RRC reconfiguration message including the determined best cell prediction configuration information to the terminal. The terminal may receive the RRC reconfiguration message including the best cell prediction configuration information from the base station, and the terminal may transmit an RRC reconfiguration complete message to the base station in response to the RRC reconfiguration message. Thereafter, the terminal may transmit a best cell prediction report message to the base station based on the best cell prediction configuration information periodically or when a specific event occurs. In other words, the terminal may report best cell prediction results to the base station. Here, the best cell prediction report message may include the best cell prediction results.

In step S610, the base station may transmit an RRC reconfiguration message (e.g. RRCReconfiguration message) including the best cell prediction configuration information (e.g. BestCellPredictionConfig IE) to the terminal. The terminal may receive the message including the best cell prediction configuration information from the base station.

When the RRCReconfiguration message is used in step S610, the BestCellPredictionConfig IE, which is the best cell prediction configuration information, may be expressed as bestCellPredictionConfig IE.

In step S620, the terminal may transmit an RRC reconfiguration complete message (e.g. RRCReconfigurationComplete message) to the base station in response to the RRC reconfiguration message received in step S610. The base station may receive the RRC reconfiguration complete message from the terminal in response to the RRC reconfiguration message transmitted in step S610.

Thereafter, the terminal may perform step S630 based on the best cell prediction configuration information, and periodically or aperiodically transmit the best cell prediction report message to the base station.

In step S630, the terminal may periodically or aperiodically transmit the best cell prediction report message (e.g. BestCellPredictionReport message) to the base station based on the best cell prediction configuration information received in step S610. The base station may receive the best cell prediction report message from the terminal periodically or aperiodically. When a specific event occurs, the best cell prediction report message may be transmitted aperiodically to the base station, and may include the best cell prediction results (e.g. BestCellPredictionResults IE).

In an exemplary embodiment, the base station may include the best cell prediction configuration information in the RRC reconfiguration message as shown in FIG. 6, and transmit the RRC reconfiguration message to the terminal.

In another exemplary embodiment, the base station may include the best cell prediction configuration information in measurement configuration information (e.g. measConfig IE) as shown in FIG. 5, and transmit an RRC reconfiguration message including it to the terminal.

In another exemplary embodiment, the terminal may transmit the best cell prediction results to the base station using the measurement report message (e.g. MeasurementReport message). In other words, the measurement report message may include the best cell prediction results (e.g. bestCellPredictionResults IE).

In another exemplary embodiment, the base station may configure the best cell prediction as needed for a terminal capable of performing the best cell prediction according to terminal capability information (e.g. UECapabilityInformation IE). The base station may include an indicator indicating the best cell prediction (e.g. bestCellPredictionFlag IE) in the RRC reconfiguration message, and transmit the RRC reconfiguration message to the terminal.

In another exemplary embodiment, the terminal may receive the RRC reconfiguration message from the base station including the indicator indicating the best cell prediction. The terminal may transmit an RRC reconfiguration complete message to the base station in response to the received RRC reconfiguration message including the indicator. Then, the terminal may perform the best cell prediction on its own.

### Best Cell Prediction Procedure for the Terminal

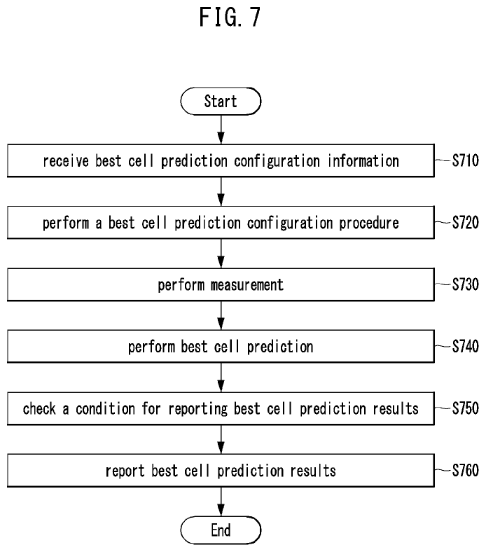

FIG. 7 is a flowchart for describing a best cell prediction procedure of a terminal according to an exemplary embodiment of the present disclosure.

Referring to FIG. 7, the terminal may receive the RRC reconfiguration message including the best cell prediction configuration information from the base station. The terminal may perform a best cell prediction configuration procedure, and configure information required for prediction. The terminal may measure signal strengths of a serving cell and neighbor cell(s) according to the configured signal strength measurement configuration information. When best cell prediction is activated, the terminal may perform the best cell prediction based on the signal strength measurement results. The terminal may check whether best cell prediction results satisfy a condition for reporting to the base station according to the best cell prediction configuration information. If it is determined that the best cell prediction results satisfy the condition for reporting to the base station, the terminal may perform a best cell prediction result reporting procedure. If necessary, when signal strength measurement is performed, the terminal may repeat the remaining steps starting from the signal strength measurement step. In addition, the terminal may receive an RRC reconfiguration message from the base station that releases, modifies, or newly configures the best cell prediction configuration information. The terminal may perform a best cell prediction configuration procedure, and may release, modify, or newly configure information required for prediction. Then, when best cell prediction is activated and signal strength measurement is performed, the terminal may repeat the remaining steps starting from the signal strength measurement step.

In step S710, the terminal may receive an RRC reconfiguration message (e.g. RRCReconfiguration message) related to the best cell prediction from the base station. The best cell prediction configuration information may be included in the RRC reconfiguration message (hereinafter referred to as ‘first RRC reconfiguration message’).

In step S720, the terminal may perform the best cell prediction configuration procedure. When the best cell prediction configuration procedure is performed, the terminal may configure the best cell prediction configuration information received in the first RRC reconfiguration message in step S710 as the information required for performing the best cell prediction.

In step S730, the terminal may perform measurement on signal strengths of the serving cell and neighbor cell(s) based on the signal strength measurement configuration information. When measurement on the signal strengths of the serving cell and neighbor cell(s) is performed, the terminal may obtain (or generate) signal strength measurement value (measurement result) of each of the serving cell and neighbor cell(s).

In step S740, when the best cell prediction is activated, the terminal may perform the best cell prediction based on the signal strength measurement results, and generate the best cell prediction results.

In an exemplary embodiment, the base station may transmit the first RRC reconfiguration message to the terminal by including an indicator (e.g. bestCellPredictionFlag IE) indicating the best cell prediction in step S710. The terminal may receive the indicator indicating the best cell prediction from the base station.

In an exemplary embodiment, the indicator indicating the best cell prediction may be set to ‘true’ or ‘false’ to indicate activation or deactivation of the best cell prediction. When the indicator indicating the best cell prediction is set to ‘true’, the indicator indicating the best cell prediction may indicate activation of the best cell prediction. The terminal may set the best cell prediction to activated state. On the other hand, when the indicator indicating the best cell prediction is set to ‘false’, the indicator indicating the best cell prediction may indicate deactivation of the best cell prediction. The terminal may set the best cell prediction to deactivated state.

In an exemplary embodiment, the base station may transmit the first RRC reconfiguration message that does not include the indicator indicating the best cell prediction to the terminal in step S710. When the indicator indicating the best cell prediction is not included in the received RRC reconfiguration message, the terminal may not change the state of the best cell prediction.

In another exemplary embodiment, the base station may transmit the first RRC reconfiguration message to the terminal in step S710 by including the indicator (e.g. bestCellPredictionFlag IE) indicating the best cell prediction. The terminal may receive the indicator indicating the best cell prediction from the base station.

In another exemplary embodiment, the indicator indicating the best cell prediction may indicate activation of the best cell prediction. When the indicator indicating the best cell prediction is included in the first RRC reconfiguration message received in step S710, the terminal may set the best cell prediction to activated state. On the other hand, when the indicator indicating the best cell prediction is not included in the first RRC reconfiguration message received in step S710, the terminal may set the best cell prediction to deactivated state.

In the above-described exemplary embodiments, when the best cell prediction is set to the activated state, the terminal may perform step S750 to perform the best cell prediction.

In step S750, the terminal may check whether a condition for reporting to the base station is satisfied for the best cell report prediction results based on the best cell prediction configuration information configured in step S720. If it is identified that the condition for reporting to the base station is satisfied, the terminal may perform step S760 to perform a best cell prediction result reporting procedure.

In step S760, the terminal may report results of the best cell prediction performed in step S740 (‘best cell prediction results’) to the base station.

If necessary, the terminal may repeatedly perform steps S730 to S760. Additionally, the terminal may receive an RRC reconfiguration message related to the best cell prediction (hereinafter, ‘second RRC reconfiguration message’) that is different from the first RRC reconfiguration message received in step S710 from the base station. The second RRC reconfiguration message may be a message for releasing, modifying, or reconfiguring the best cell prediction configuration information. The terminal may perform step S720, and may release, modify, or reconfigure the best cell prediction information in step S720. When the best cell prediction is activated, the terminal may repeatedly perform steps S730 to S760 based on the modified or reconfigured cell prediction configuration information.

### Best Cell Prediction Configuration Information

The base station may transmit an RRC reconfiguration message (e.g. RRCReconfiguration message) including the best cell prediction configuration information (e.g. bestCellPredictionConfig) to the terminal. The terminal may receive the RRC reconfiguration message including the best cell prediction configuration information from the base station. The best cell prediction configuration information may be shown in Table 4.

TABLE 4

| | |
|---|---|
| BestCellPredictionConfig ::= | SEQUENCE { |
| bestCellPredictionId | BestCellPredictionId, |
| useModelId | ModelId, |
| bestCellPredictionConfig | BestCellPredictionConfig, |
| s-BestCellPredictionConfig | CHOICE { |
| ssb-RSRP | RSRP-Range, |
| csi-RSRP | RSRP-Range |

},

| | |
|---|---|
| quantityBestCellPredictionConfig | QuantityBestCellPredictionConfig, |
| reportBestCellPredictionConfig | ReportBestCellPredictionConfig, |

...,
}

Table 4 is an example of an exemplary embodiment for describing the best cell prediction configuration information.

Referring to Table 4, the best cell prediction configuration information may include the following key fields (or parameters):
bestCellPredictionId: This may indicate a best cell prediction identifier (ID).
useModelId: This may indicate an ID of an ML model to be used for best cell prediction. When the terminal manages the ML model on its own, useModelId may be omitted or ignored. When the base station manages the ML model, the base station may deliver the ML model to the terminal in advance. The terminal may use the ML model depending on configuration by the base station.
bestCellPredictionConfig: This may indicate the best cell prediction configuration information. Depending on a need, this may include at least one pair of [inputWindowTime, outputWindowTime] to perform the best cell prediction.
s-BestCellPredictionConfig: This may be configured not to perform the best cell prediction when the signal strength of the serving cell is equal to or greater than a specific threshold.
quantityBestCellPredictionConfig: This may include configuration information of an L3 filter for the best cell prediction. This may be configured in the same form as a quantityConfig field of the MeasConfig IE.
reportBestCellPredictionConfig: This may include configuration information for reporting the best cell prediction results to the base station.

In Table 4, bestCellPredictionConfig may include at least one pair of [inputWindowTime, outputWindowTime] to perform the best cell prediction as needed. For example, prediction on the best cell for the next 5 seconds may be performed based on signal strength measurement results for the previous 10 seconds. In this case, [inputWindowTime, outputWindowTime] may be set to [10 seconds, 5 seconds]. When the pair of [inputWindowTime, outputWindowTime] is already determined by the ML model, the pair of [inputWindowTime, outputWindowTime] may be omitted or ignored.

Depending on a need such as the capability of the terminal, not only the signal strength measurement results but also location information may be used as input data for predicting the best cell. When location information is used as input data for the best cell prediction, a flag uselocationInfoInput may be set. When the flag uselocationInfoInput is set, the terminal may also apply the location information as input data when applying the signal strength measurement results as input data for predicting the best cell.

If the flag uselocationInfoInput is not set, the terminal may apply only the signal strength measurement results as input data for predicting the best cell. For the best cell prediction, L1 measurement results may be used without applying a filter, may be used by applying only the L1 filter, or may be used by applying both the L1 filter and the L3 filter. When the best cell prediction is performed by applying filter(s), the best cell prediction configuration information may include information on the applied filter(s).

Meanwhile, when the best cell prediction is performed, a signal quality of a cell (i.e. cell quality) and a signal quality of a beam (i.e. beam quality) may be applied. The best cell prediction configuration information may further include information related thereto. In general, the cell quality may be applied to perform the best cell prediction. When a flag useBeamQuality is set in the best cell prediction configuration information, the best cell prediction may be performed by applying the beam quality. When a flag useCellBeamQuality is set, the best cell prediction may be configured to simultaneously perform prediction applying the cell quality and prediction applying the beam quality.

In Table 4, s-BestCellPredictionConfig may be set to prevent the best cell prediction from being performed when the signal strength of the serving cell is equal to or greater than a specific threshold. s-BestCellPredictionConfig may be configured in the same form as the s-MeasureConfig field of the MeasConfig IE. Additionally, the best cell prediction configuration information may further include field(s) related to signal strengths of neighbor cells. The best cell prediction configuration may configure the best cell prediction not to be performed when signal strength(s) of neighbor cell(s) are equal to or less than a specific threshold, or when a difference between the signal strength(s) of neighbor cell(s) and the signal strength of the serving cell is equal to or less than a specific offset.

In Table 4, quantityBestCellPredictionConfig may include configuration information on the L3 filter for the best cell prediction. quantityBestCellPredictionConfig may be configured in the same form as the quantityConfig field in the MeasConfig IE.

In Table 4, reportBestCellPredictionConfig may include configuration information for reporting the best cell prediction results to the base station. The base station may configure the terminal to periodically report the best cell prediction results. A reporting periodicity may be included in reportBestCellPredictionConfig. Additionally or alternatively, the base station may configure the terminal to report the best cell prediction results when a specific event occurs. The specific event may be a case when the best cell changes. Additionally or alternatively, the specific event may be a case when the best cell changes and a time during which the cell is maintained as the best cell is equal to or longer than a specific time. In this case, reportBestCellPredictionConfig may include information on the event and information on the specific time.

As shown in Table 4, best cell prediction result report configuration information may be included in the best cell prediction configuration information. The terminal may transmit a best cell prediction result report message to the base station based on the best prediction result report configuration information included in the best cell prediction configuration information. The best cell prediction result report message may be transmitted to the base station periodically or aperiodically.

On the other hand, the best cell prediction result report configuration information may be included in the measurement report configuration information. When the best cell prediction result report configuration information is included in the measurement report configuration information, the terminal may include the best cell prediction result report in the measurement report message (e.g. MeasurementReport message) and transmit it to the base station. The terminal may report the signal strength measurement results by transmitting the measurement report message to the base station periodically or when a specific event occurs according to the configured signal strength measurement configuration information.

As an exemplary embodiment, reportConfigToAddModList of the MeasConfig IE may provide signal strength measurement result report configuration information. ReportBestCellPredictionConfig may include configuration information that disables triggered reporting of signal strength measurement results based on the best cell prediction results. If a time during which a cell for which reporting of signal strength measurement results is triggered is maintained as the best cell is predicted to be shorter than a specific time by the best cell prediction results, it may be configured not to report the signal strength measurement results.

As another exemplary embodiment, it may be configured to report a result of predicting the best N cells. A prediction result report condition may follow a best cell prediction result report condition according to reportBestCellPredictionConfig configuration information. There may be different manners to construct the BestCellPredictionReport message.

As another exemplary embodiment, the bestCellPredictionConfig IE may be configured in conjunction with the measConfig IE.

As another exemplary embodiment, the bestCellPredictionConfig IE may be configured in conjunction with MeasId or MeasObjectId configured in the measConfig IE. When performing the best cell prediction, the best cell prediction may be performed for cell(s) corresponding to MeasId or MeasObjectId.

As another exemplary embodiment, the base station may configure information on cell(s) on which the best cell prediction is to be performed to the terminal by including the information in the bestCellPredictionConfig IE. The terminal may perform the best cell prediction on the cell(s) indicated by the information.

In another exemplary embodiment, when the terminal determines a handover, cell switching, or cell addition/change (e.g. conditional handover, conditional cell addition/change, or terminal-based LTM cell switching), the terminal may be configured to perform the handover or cell switching based on the best cell prediction results. The base station may be configured to use information on the predicted best cell for conditional handover, conditional cell addition/change, and terminal-based LTM cell switching configuration information. In addition, a specific condition may be additionally configured so that the handover or cell switching is executed when the information on the predicted best cell satisfies the specific condition. If there is no specific condition, the terminal may decide to execute the handover or cell switching based on the information on the predicted best cell.

### Best Cell Prediction Activation Control Method

As shown in FIG. 6, the terminal may configure the best cell prediction configuration information through the best cell prediction configuration signaling procedure, and activate or deactivate the best cell prediction. A method for controlling activation of the best cell prediction of the terminal may consider exemplary embodiments below.

As a first exemplary embodiment, the base station may configure the best cell prediction of the terminal through the best cell prediction configuration signaling procedure. When the best cell prediction is configured, the terminal may immediately activate the best cell prediction.

In the first exemplary embodiment, the base station may release the best cell prediction of the terminal configured through the best cell prediction configuration signaling procedure. If the configured best cell prediction is released, the terminal may immediately deactivate the best cell prediction.

As a second exemplary embodiment, the base station may transmit a separate message indicating activation or deactivation of the best cell prediction to the terminal in which the best cell prediction is configured. Here, the separate message may be a MAC CE or RRC message.

In the second exemplary embodiment, the terminal may receive the separate message from the base station. The terminal may activate or deactivate the best cell prediction based on the received separate message. In other words, if the separate message indicates activation of the best cell prediction, the terminal may activate the best cell prediction. If the separate message indicates deactivation of the best cell prediction, the terminal may deactivate the best cell prediction.

As a third exemplary embodiment, the base station may configure a best cell prediction execution condition to the terminal. The best cell prediction execution condition may be configured before the best cell prediction configuration signaling procedure is performed. Here, the best cell prediction execution condition may be a condition for executing the best cell prediction when signal strength(s) measured at the terminal satisfy a specific condition.

In the third exemplary embodiment, the base station may configure the best cell prediction of the terminal through the best cell prediction configuration signaling procedure. When the best cell prediction is configured, the terminal may check whether the signal strength measurement results satisfy a specific condition. If the signal strength measurement results are identified to satisfy the specific condition, the terminal may activate or deactivate the best cell prediction.

In the third exemplary embodiment, the specific condition may be an event defined in ‘Measurement report triggering’ specified in the 3GPP RRC technical specification.

As a fourth exemplary embodiment, the best cell prediction of the terminal may be configured through the best cell prediction configuration signaling procedure. When the best cell prediction is configured, the terminal may not perform the best cell prediction if a signal strength of the serving cell is equal to or greater than a specific threshold.

In the fourth exemplary embodiment, the base station may transmit best cell prediction configuration information (hereinafter, ‘first best cell prediction configuration information’) including s-BestCellPredictionConfig to the terminal as shown in Table 4. The terminal may receive the first best cell prediction configuration information from the base station. The terminal may be configured not to perform the best cell prediction if a signal strength of the serving cell is equal to or greater than the specific threshold. The terminal may be configured to perform the best cell prediction in other cases. Here, the specific threshold may be included in s-BestCellPredictionConfig.

As a fifth exemplary embodiment, the base station may configure the best cell prediction of the terminal through the best cell prediction configuration signaling procedure. When the best cell prediction is configured, the terminal may not perform the best cell prediction if a signal strength of the serving cell is equal to or less than a specific threshold.

In the fifth exemplary embodiment, the base station may transmit second best cell prediction configuration information, and the terminal may receive the second best cell prediction configuration information from the base station. The second best cell prediction configuration information may include the specific threshold. The terminal may be configured not to perform the best cell prediction if a signal strength of the serving cell is equal to or less than the specific threshold. The terminal may be configured to perform the best cell prediction in other cases.

As a sixth exemplary embodiment, the base station may configure the best cell prediction of the terminal through the best cell prediction configuration signaling procedure. When the best cell prediction is configured, the terminal may not perform the best cell prediction when a difference between signal strength(s) of neighbor cell(s) and a signal strength of the serving cell is equal to or less than a specific offset.

In the sixth exemplary embodiment, the base station may transmit third best cell prediction configuration information, and the terminal may receive the third best cell prediction configuration information from the base station. The third best cell prediction configuration information may include the specific offset. The terminal may be configured not to perform the best cell prediction if a difference between signal strength(s) of neighbor cell(s) and a signal strength of the service cell is equal to or less than the specific offset. The terminal may be configured to perform the best cell prediction in other cases. The third best cell prediction configuration information may include information on the specific offset.

### Best Cell Prediction Result Reporting Method

The best cell prediction results may be transmitted as being included in the best cell prediction report message. Additionally or alternatively, the best cell prediction results may be transmitted as being included in the measurement report message. The terminal may transmit the best cell prediction results to the base station according to methods below.

### Method 1) Report the Best Cell Prediction Results Using the Best Cell Prediction Report Message

The best cell prediction results may be transmitted to the base station as being included in the best cell prediction report message. The best cell prediction results may be included in the best cell prediction report message as follows.

The base station may configure the best cell prediction results to be reported periodically. The terminal may transmit the best cell prediction report message including the best cell prediction results to the base station according to a set reporting periodicity. Additionally or alternatively, the base station may configure a specific event to report the best cell prediction results aperiodically. When the specific event occurs, the terminal may aperiodically transmit the best cell prediction report message including the best cell prediction results to the base station.

For example, if the best cell is changed, a specific event may occur. Additionally or alternatively, if the best cell is changed and a time during which the corresponding cell is maintained as the best cell is equal to or longer than a specific time, a specific event may occur.

A specific event may occur based on the signal strength measurement configuration information. Additionally or alternatively, a specific event may occur depending on the best cell prediction configuration information. When a specific event occurs, the terminal may transmit the best cell prediction report message (e.g. BestCellPredictionReport message) to the base station. In other words, the terminal may report the best cell prediction results to the base station.

In a first exemplary embodiment, the best cell prediction report message (e.g. BestCellPredictionReport message) may include the best cell prediction results (e.g. bestCellPredictionResults IE). The best cell prediction results may include a cell identifier (cell ID) of the best cell.

In the first exemplary embodiment, the best cell prediction results may include a start time of the best cell and/or a duration of the best cell. In other words, the best cell prediction results may indicate a start time at which a specific cell is the best cell and a time during which the specific cell is predicted to be maintained as the best cell from the start time. Therefore, a specific cell which is maintained as the best cell for a very short period of time may be excluded from the best cell prediction results.

On the other hand, the best cell prediction results may include one start time. When one start time is included in the best cell prediction results, prediction results for a plurality of best cells may be included in the best cell prediction report message (e.g. BestCellPredictionReport message). The plurality of predicted best cells may be considered to be consecutive from the one start time. In this case, the best cell prediction report may include even the best cell which is maintained during a very short period of time.

As a second exemplary embodiment, the best cell prediction report message (e.g. BestCellPredictionReport message) may include the best cell prediction results (e.g. bestCellPredictionResults IE). The best cell prediction results may include beam signal quality.

In the second exemplary embodiment, the best cell prediction report message may include a beam identifier (beam ID).

As a third exemplary embodiment, the cell prediction results may include a result of predicting the best N cells. Additionally or alternatively, the cell prediction results may include cell identifiers (cell IDs) of the best N cells. The cell prediction results may include a start time and a duration of each of the best N cells. Here, the start times and durations of the respective best N cells may be arranged in an order of the cells.

As a third exemplary embodiment, the cell prediction results may indicate a start time of the order of the best N cells and a time during which the cells are predicted to be maintained as the best cells in the same order. The best cell which is maintained during a very short period of time among the best N cells may be excluded from the best cell prediction results.

As a fourth exemplary embodiment, the cell prediction results may include a result of predicting the best N cells. Additionally or alternatively, the cell prediction results may include cell identifiers (cell IDs) of the best N cells. The cell prediction results may include only a start time.

In the fourth exemplary embodiment, the best N cells may be considered to be consecutive from the one start time. Therefore, the best cell prediction report may include even the best cell which is maintained during a very short period of time.

As a fifth exemplary embodiment, the best cell prediction report may include beam signal quality.

In the fifth exemplary embodiment, the cell prediction result may include a beam identifier (beam ID).

As a sixth exemplary embodiment, the best cell prediction results (e.g. bestCellPredictionResults IE) may be transmitted to the base station as being included in the measurement report message (e.g. MeasurementReport message).

In the sixth exemplary embodiment, the terminal may transmit a periodic measurement report message to the base station according to the configured signal strength measurement configuration information. Additionally or alternatively, the terminal may aperiodically transmit the measurement report message to the base station according to the configured signal strength measurement configuration information. Additionally or alternatively, when a specific event occurs, the terminal may aperiodically transmit the best cell prediction report message (e.g. BestCellPredictionReport message) to the base station.

### Method 2) Report the Best Cell Prediction Result Using a Measurement Report Message

The best cell prediction results may be reported to the base station using a measurement report message. The best cell prediction results may be included in the measurement report message as follows.

As a first exemplary embodiment, the measurement report message (e.g. MeasurementReport message) may include the best cell prediction results (e.g. bestCellPredictionResults).

In the first exemplary embodiment, the measurement report message may be configured as Table 5 and Table 6.

TABLE 5

| | |
|---|---|
| MeasurementReport ::= | SEQUENCE { |
| criticalExtensions | CHOICE { |
| measurementReport | MeasurementReport-IEs, |
| criticalExtensionsFuture | SEQUENCE { } |

}
}
...

Table 5 is an example of a measurement report message.

In Table 5, the measurement report message (e.g. MeasurementReport message) may include measurement report IEs (e.g. MeasurementReport-IEs). The measurement report information may be configured as Table 6.

TABLE 6

| MeasurementReport-IEs ::= | SEQUENCE { | |
|---|---|---|
| measResults | MeasResults, | |
| lateNonCriticalExtension | OCTET STRING | OPTIONAL, |
| nonCriticalExtension | BestCellPredictionResults-IEs | OPTIONAL |

}

| BestCellPredictionResults-IE | SEQUENCE { | |
|---|---|---|
| lateNonCriticalExtension | OCTET STRING | OPTIONAL, |
| bestCellPredictionResults | BestCellPredictionResults | OPTIONAL |

}

Table 6 is an example showing the measurement report IEs included in the measurement report message.

In Table 6, the measurement report IEs (e.g. MeasurementReport-IEs) may include a best cell prediction result IE (e.g. BestCellPredictionResults-IE). The measurement report message (e.g. MeasurementReport message) may include the measurement report IEs (e.g. MeasurementReport-IEs) as shown in Table 5. In addition, the measurement report IEs may include the best cell prediction result IE (e.g. BestCellPredictionResults-IE) as shown in Table 6. In other words, the measurement report message may include the best cell prediction result IE. The terminal may transmit the best cell prediction results to the base station using the measurement report message. The base station may receive the measurement report message including the best cell prediction results from the terminal. The base station may obtain the best cell prediction results of the terminal using the measurement report message received from the terminal.

As a second exemplary embodiment, the measurement report message (e.g. MeasurementReport message) may include the measurement result information (e.g. measResults). The measurement result information may include the best cell prediction results (e.g. bestCellPredictionResults).

In the second exemplary embodiment, the measurement report message may include the measurement result information as shown in Tables 5 and 6. The measurement result information may be configured as Table 7.

TABLE 7

| | |
|---|---|
| MeasResults ::= | SEQUENCE { |
| measId | MeasId, |
| measResultServingMOList | MeasResultServMOList, |

...

| | |
|---|---|
| nonCriticalExtension | BestCellPredictionResults-IEs |

}
...

| BestCellPredictionResults-IEs ::= | SEQUENCE { | |
|---|---|---|
| lateNonCriticalExtension | OCTET STRING | OPTIONAL, |
| bestCellPredictionResults | BestCellPredictionResults | OPTIONAL |

}

Table 7 is another example for reporting the best cell prediction results using the measurement report message.

In Table 7, the measurement result IE (e.g. MeasResults IE) may include the best cell prediction results (e.g. bestCellPredictionResults). The best cell prediction results may include the best cell prediction results (e.g. bestCellPredictionResults).

In the second exemplary embodiment, the measurement report message may include measurement results (e.g. measResults) as shown in Table 6. The measurement result information may include the best cell prediction results as shown in Table 7.

### The Best Cell Prediction Feedback Procedure

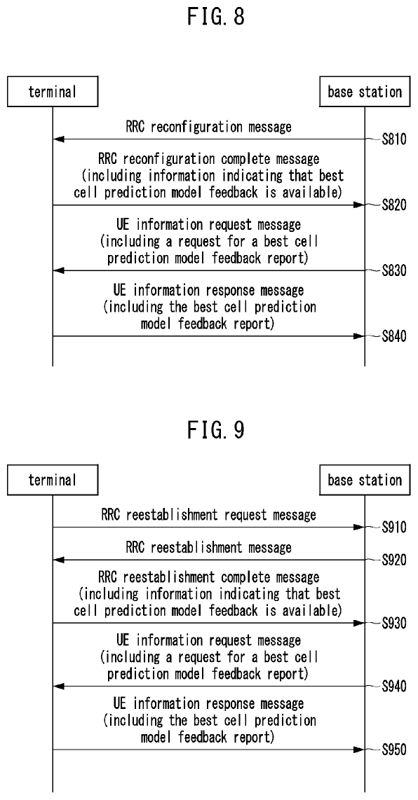

FIG. 8 is a sequence chart for describing a best cell prediction model feedback procedure according to a first exemplary embodiment of the present disclosure.

Referring to FIG. 8, a communication system may include a base station, a terminal, and the like. The base station may be the base stations 110-1, 110-2, 110-3, 120-1, or 120-2 shown in FIG. 1, and the terminal may be the terminal 130-1, 130-2, 130-3, 130-4, 130-5, or 130-6 shown in FIG. 1.

The base station may configure best cell prediction model feedback to the terminal. The terminal may transmit a prediction model feedback to the base station periodically or when a specific event occurs based on configuration. The base station and the terminal may be configured identically or similarly to the communication node shown in FIG. 2. The terminal may receive an RRC reconfiguration message from the base station. If the best cell prediction mode feedback is available, the terminal may transmit an RRC reconfiguration complete message to the base station including information indicating that the best cell prediction model feedback is available. The base station may receive the RRC reconfiguration complete message from the terminal and identify the information indicating that the best cell prediction model feedback is available. If it is identified that the best cell prediction model feedback is available, the base station may transmit a UE information request message indicating a request for a best cell prediction model feedback report to the terminal. When the terminal receives the UE information request message indicating the request for the best cell prediction model feedback report, the terminal may transmit a UE information response message including the best cell prediction mode feedback report to the base station. Here, the RRC connection between the base station and the terminal may be in the RRC connected state.

In step S810, the base station may transmit an RRC reconfiguration message (e.g. RRCReconfiguration message) to the terminal. The terminal may receive the RRC reconfiguration message from the base station.

In step S820, the terminal may include information indicating that the best cell prediction model feedback is available (e.g. bestCellPredFeedbackAvilable) in an RRC reconfiguration complete message (e.g. RRCREconfigurationComplete message) and transmit it to the base station. The base station may receive the RRC reconfiguration complete message including the information indicating that the best cell prediction model feedback is available from the terminal.

The base station may identify whether the best cell prediction model feedback is available at the terminal based on the RRC reconfiguration complete message received from the terminal in step S820. If it is identified that the best cell prediction model feedback is available at the terminal, the base station may perform step S830 to transmit a request for a best cell prediction model feedback report to the terminal.

In step S830, the base station may transmit a UE information request message including information indicating the request for the best cell prediction model feedback report to the terminal. The terminal may receive the UE information request message from the base station including the information indicating the request for the best cell prediction model feedback report.

The request for the best cell prediction model feedback report may be expressed as bestCellPredFeedbackReq. bestCellPredFeedbackReq may be set to ‘true’ or ‘false’. The case where bestCellPredFeedbackReq is set to ‘true’ may indicate that the best cell prediction model feedback report is requested.

The terminal may identify that the best cell prediction model feedback report is requested based on the UE information request message received from the base station in step S830. If it is identified that the best cell prediction model feedback report is requested, the terminal may perform step S840 to transmit the best cell prediction model feedback report to the base station.

In step S840, the terminal may transmit a UE information response message (e.g. UEInformationResponse message) including the best cell prediction model feedback report (e.g. bestCellPredFeedbackReport) to the base station. The base station may receive the UE information response message including the best cell prediction model feedback report from the terminal.

FIG. 9 is a sequence chart for describing a best cell prediction model feedback procedure according to a second exemplary embodiment of the present disclosure.

Referring to FIG. 9, a communication system may include a base station, a terminal, and the like. The base station may be the base stations 110-1, 110-2, 110-3, 120-1, or 120-2 shown in FIG. 1, and the terminal may be the terminal 130-1, 130-2, 130-3, 130-4, 130-5, or 130-6 shown in FIG. 1. The base station may configure a best cell prediction model feedback to the terminal. When the best cell prediction model feedback is configured, the terminal may periodically transmit a best cell prediction model feedback to the base station based on configuration. Additionally or alternatively, when a specific event occurs, the terminal may aperiodically transmit a best cell prediction model feedback to the base station.

In steps S910 and S920, the terminal may transmit an RRC reestablishment request message (e.g. RRCReestablishmentRequest message) to the base station (S910), and the base station may transmit an RRC reestablishment message (e.g. RRCReestablishment message) in response to the RRC reestablishment request message (S920).

In step S930, the terminal may transmit information indicating that the best cell prediction model feedback is available (e.g. bestCellPredFeedbackAvilable) to the base station by including it in an RRC reestablishment complete message (e.g. RRCReestablishmentComplete message). The base station may receive the RRC reestablishment complete message from the terminal including the information indicating that the best cell prediction model feedback is available.

The base station may identify whether the best cell prediction model feedback is available at the terminal based on the RRC reestablishment complete message received from the terminal in step S930. If it is identified that the best cell prediction model feedback is available at the terminal, the base station may perform step S940 to transmit a request for a best cell prediction model feedback report to the terminal.

In step S940, the base station may transmit a UE information request message including information indicating the request for the best cell prediction model feedback report to the terminal. The terminal may receive the UE information request message from the base station including the information indicating the request for the best cell prediction model feedback report.

The request for the best cell prediction model feedback report may be expressed as bestCellPredFeedbackReq. bestCellPredFeedbackReq may be set to ‘true’ or ‘false’. The case where bestCellPredFeedbackReq is set to ‘true’ may indicate that the best cell prediction model feedback report is requested.

The terminal may identify that the best cell prediction model feedback report is requested based on the UE information request message received from the base station in step S940. If it is identified that the best cell prediction model feedback report is requested, the terminal may perform step S950 to transmit a best cell prediction model feedback report to the base station.

In step S950, the terminal may transmit a UE information response message (e.g. UEInformationResponse message) including the best cell prediction model feedback report (e.g. bestCellPredFeedbackReport) to the base station. The base station may receive the UE information response message including the best cell prediction model feedback report from the terminal.

### Ping-Pong Handover Reduction Signaling Procedure Using Previous Handover Information

When a ping-pong handover phenomenon occurs during a handover or cell switching process, communication quality may be significantly degraded due to unnecessary data transmission and recovery procedures. Information on previous handover(s) or cell switching(s) may be used, and a signal strength offset may be applied to a source cell of the previous handover. Unnecessary ping-pong handovers can be reduced.

After accessing a new target cell during a handover or cell switch process, if a handover is attempted again to the source cell of the previous handover, the handover may be classified into a ping-pong handover or a non-ping-pong handover. Even when a movement path of the terminal is configured as a path from the source cell to the target cell and then from the target cell to the source cell, the handover may be classified as a non-ping-pong handover. For example, if a dwell time in the target cell is equal to or longer than a specific time, the handover may be classified as a non-ping-pong handover. Therefore, using the previous handover information, the frequency of unnecessary ping-pong handovers can be more accurately reduced.

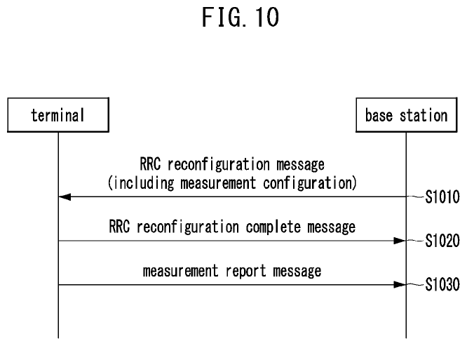

FIG. 10 is a sequence chart for describing an exemplary embodiment of a ping-pong handover reduction signaling procedure using previous handover information according to the present disclosure.

Referring to FIG. 10, the base station may configure a best cell prediction model feedback to the terminal. The terminal may transmit a prediction model feedback report to the base station periodically or when a specific event occurs based on configuration.

The base station may configure signal strength measurement configuration information according to capability of the terminal, network configuration information, or the like. The base station may determine signal strength measurement configuration information for the terminal, configure it as the measConfig IE, and transmit an RRC reconfiguration message including it to the terminal (S1010). The terminal receiving the RRC reconfiguration message may transmit an RRC reconfiguration complete message to the base station in response thereto (S1020). The measConfig IE described above may include a signal strength offset to be applied to the source cell of the previous handover. Then, the terminal may measure signal strengths of the source cell and neighbor cell(s) according to the configured signal strength measurement configuration information, and check whether a MeasurementReport message is triggered by occurrence of a specific event according to ReportConfig of the configured measConfig IE. In this case, a condition of the specific event is checked using the signal strength offset applied to the source cell of the previous handover described above. For example, an entering condition for event A3 may be expressed as Equation 1 below.

$$Mn + Ofn + Ocn - Ocps - Hys > Mp + Ofp + Ocp + Off \qquad [ Equation 1 ]$$

In Equation 1, Ocp represents the signal strength offset to be applied to the source cell of the previous handover. Similarly, an entering condition for event A4 may be expressed as Equation 2 below.

$$Mn + Ofn + Ocn - Ocps - Hys > Thresh \qquad [ Equation 2 ]$$

The terminal may report signal strength measurement results by transmitting a MeasurementReport message to the base station periodically or when the above-mentioned specific event occurs (S1030). The MeasurementReport message may include an measResults IE, which corresponds to the signal strength measurement results.

The signal strength offset Ocps to be applied to the source cell of the previous handover may be included in the measConfig IE or in ReportConfig or MeasObject included in the measConfig IE. The signal strength offset may be equally applied when the terminal determines a handover, cell switching, or cell addition/change (e.g. conditional handover, conditional cell addition/change, and terminal-based LTM cell switching). For this purpose, it may be configured as being included in CondTriggerConfig included in ReportConfig included in the measConfig IE. In addition, a scaling factor depending on a movement speed of the terminal may be applied to the signal strength offset Ocps to be applied to the source cell of the previous handover. For example, if the movement speed is a high speed, the scaling factor may be set to 0.25, and if the movement speed is a medium speed, the scaling factor may be set to 0.5.

Information on the source cell of the previous handover may be managed by the terminal or the base station. When managed by the terminal, the terminal may maintain variable(s) including information on the source cell of the previous handover. The variable(s) may include a cell identifier of the source cell of the previous handover. When managed by the base station, information on the source cell of the previous handover may be included in CellsToAddMod included in MeasObject included in the measConfig IE.

The occurrence of ping-pong handovers can be further reduced by using a large value for the signal strength offset Ocps to be applied to the source cell of the previous handover. However, a probability of handover failure may increase due to handover triggering delayed by the large signal strength offset. Accordingly, the signal strength offset may be limited to be applied only when cell configuration information is configured in advance for the source cell of the previous handover in a conditional handover, conditional cell addition/change, and terminal-based LTM cell switching. The base station may configure this information to the terminal.

### Ping-Pong Handover Reduction Procedure Using Previous Handover Information

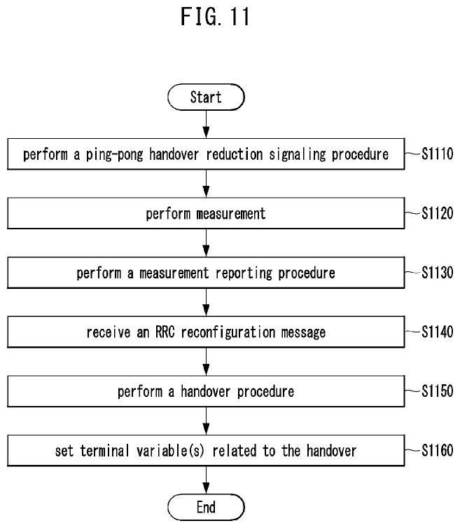

FIG. 11 is a flowchart for describing an exemplary embodiment of a procedure of a terminal that reduces occurrences of ping-pong handover using previous handover information according to the present disclosure.

Referring to FIG. 11, the terminal may perform a signal strength measurement configuration procedure to reduce occurrence of ping-pong handovers based on signal strength measurement configuration information received from the base station. Then, the terminal may measure signal strengths of the source cell and neighbor cell(s) based on the configured signal strength measurement configuration information. The terminal may check whether a specific event for reporting signal strength measurement results occurs. The terminal may check a condition of the specific event by using the signal strength offset to be applied to the source cell of the previous handover. The terminal may periodically transmit a measurement report message to the base station. Additionally or alternatively, when a specific event occurs, the terminal may aperiodically transmit a measurement report message to the base station. The base station may determine a handover based on the signal strength measurement results received from the terminal, and may indicate the handover to the terminal by transmitting an RRC reconfiguration message to the terminal. The terminal may receive the RRC reconfiguration message and execute the handover. Alternatively, the terminal may execute the handover when a specific condition is satisfied in a conditional handover scheme. After executing the handover, the terminal may set UE variable(s) including information on the previous handover.

In step S1110, the terminal may perform a signal strength measurement configuration procedure to reduce occurrence of ping-pong handovers based on signal strength measurement configuration information received from the base station. The terminal may configure signal strength measurement configuration information. The terminal may perform step S1120 to measure signal strengths based on the configured signal strength measurement configuration information.

In steps S1120 and S1130, the terminal may measure signal strengths of the source cell and neighbor cell(s) based on the configured signal strength measurement configuration information and generate measurement results (S1120). The terminal may periodically or aperiodically transmit a measurement report message including the signal strength measurement results to the base station. The base station may receive the measurement report message including the signal strength measurement results from the terminal (1130).

The terminal may check whether a specific event for reporting the signal strength measurement results occurs. The terminal may check a condition for the specific event by using the signal strength offset to be applied to the source cell of the previous handover. When a specific event occurs, the terminal may aperiodically transmit a measurement report message to the base station.

The base station may determine a handover based on the received signal strength measurement results of the terminal, and may indicate the handover to the terminal by transmitting an RRC reconfiguration message (e.g. RRCReconfiguration message) to the terminal.

In step S1140, the terminal may receive the RRC reconfiguration message from the base station (S1140). If the RRC reconfiguration message indicates a handover command, the terminal may perform step S1150 to perform a handover procedure.

Alternatively, if a specific condition for the conditional handover scheme is satisfied, the terminal may perform step S1150 to perform the handover procedure.

In steps S1150 and S160, the terminal may perform the handover procedure (S1150). After executing the handover, the terminal may set UE variable(s) storing information on the previous handover (S1160).

### Ping-Pong Handover Reduction Method Using Previous Handover Information

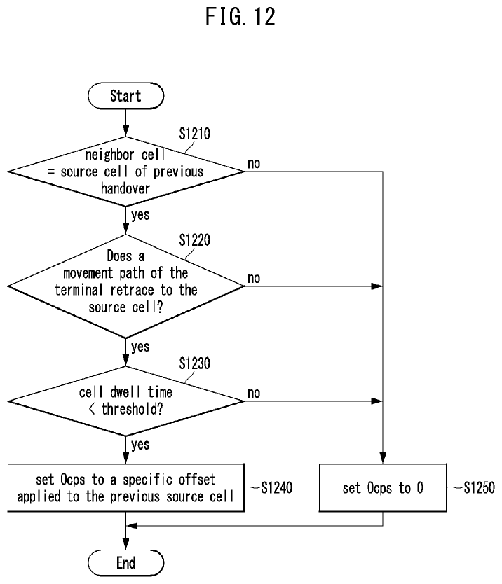

FIG. 12 is a flowchart for describing an embodiment exemplary of a method for reducing occurrence of ping-pong handovers using previous handover information according to the present disclosure.

Referring to FIG. 12, if a neighbor cell is not a source cell of the previous handover, O cps may be set to 0. If a neighbor cell is the source cell of the previous handover, the signal strength offset applied to the source cell of the previous handover may be set to Ocps. Even when a movement path of the terminal is a path from the source cell to the target cell and then from the target cell to the source cell (when the movement path of the terminal is a retracing path), a handover may be classified as a non-ping-pong handover. Accordingly, Ocps may be set to 0. When such determination is made at the terminal, the base station may configure whether to apply the rule to the terminal. If a cell dwell time during which the terminal is connected to the target cell is longer than a specific time, the handover may be classified as a non-ping-pong handover, and Ocps may be set to 0 accordingly. When such determination is made at the terminal, the base station may configure the terminal whether to apply the rule.

To calculate the cell dwell time in the target cell, the terminal may set a handover execution time in the UE variable(s) storing previous handover information. The base station may calculate the cell dwell time from a start time at which the terminal accesses the cell. Additionally or alternatively, if necessary, the base station may request a report on the previous handover execution time from the terminal.

In order to identify the movement path of the terminal, the terminal may configure a location of the terminal at a time of executing the handover in the terminal variable(s) storing previous handover information. Whether the movement path of the terminal is a retracing path from the source cell to the target cell and then from the target cell to the source cell may be identified based on the location of the terminal at a time of executing the previous handover, the location of the terminal at a time of executing a handover immediately before the previous handover, and the current location of the terminal. Alternatively, the location of the terminal when a handover-related event occurs may be set in the terminal variable(s) storing previous handover information. For example, the location of the terminal when an A3 offset of 0 dB occurs may be recorded for each neighbor cell. Through this, it may be identified whether the movement path of the terminal is a retracing path based on the location of the terminal at a time when a handover-related event of the previous handover occurs, the location of the terminal at the time of executing the previous handover, and the current location of the terminal. This method may identify a ping-pong handover more accurately than the previously described method. Alternatively, the location of the terminal when receiving cell configuration information of a target cell may be set in the terminal variable(s) storing previous handover information. The base station may configure the terminal whether to set the location of the terminal when a handover-related event occurs in the terminal variable(s). If necessary, the base station may request from the terminal a report on the location of the terminal at the time of executing the previous handover and, if configured, may further request from the terminal a report on the location of the terminal at the time of occurrence of a handover-related event of the previous handover.

The base station may configure the terminal to report information on the previous handover immediately after completing the handover. The terminal may report information on the previous handover to the base station as needed without a request from the base station. Additionally or alternatively, the terminal may set a handover type in the terminal variable(s) storing previous handover information. The handover type may be classified into a normal handover, conditional handover, or LTM handover. Additionally or alternatively, the terminal may set signal strength measurement results of the source cell and target cell when executing the handover in the terminal variable(s) storing previous handover information. If necessary, the terminal may set signal strength measurement results for the best N neighbor cells. The base station may set N to the terminal. In addition, the terminal may set the signal strength measurement results of the source cell and target cell when receiving configuration information of the target cell in the terminal variable(s) storing previous handover information.

### Mobility Management Performance Enhancing Apparatus

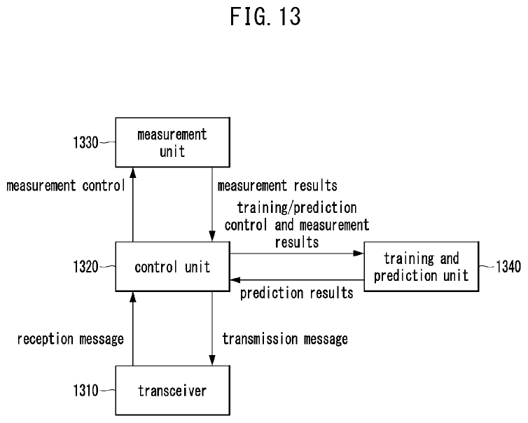

FIG. 13 is a block diagram illustrating an exemplary embodiment of a mobility management performance enhancing apparatus according to the present disclosure.

Referring to FIG. 13, a cell change prediction apparatus in a communication system may include a transceiver 1310, a control unit 1320, a measurement unit 1330, and a training and prediction unit 1340. Here, the transceiver 1310 may receive a message including measurement control-related information and training and prediction control-related information from the base station, and deliver the received message to the control unit 1320. The control unit 1320 may receive the message from the transceiver 1310 and deliver the measurement control-related information of the received message to the measurement unit 1330. Then, the control unit 1320 may deliver the training and prediction control-related information of the received message to the training and prediction unit 1340.

The measurement unit 1330 may receive the measurement control-related information from the control unit 1320, and measure received signal strengths of the serving cell and neighbor cell(s) according to the received measurement control-related information. The measurement unit 1330 may deliver measurement results to the control unit 1320. Accordingly, the control unit 1320 may receive the measurement results from the measurement unit 1330, and deliver the received measurement results to the training and prediction unit 1340.

Meanwhile, the training and prediction unit 1340 may receive the training and prediction control-related information from the control unit 1320. Accordingly, the training and prediction unit 1340 may perform training on an ML model according to the training and prediction control-related information. The training and prediction unit 1340 may receive the measurement results from the control unit 1320. Accordingly, the training and prediction unit 1340 may calculate measurement prediction results using the measurement results according to the training and prediction control-related information. The training and prediction unit 1340 may transmit the measurement prediction results to the control unit 1320. The control unit 1320 may receive the measurement prediction results from the training and prediction unit 1340, and perform necessary operations according to the received measurement prediction results. Additionally, if there is information to be reported to the base station based on the measurement prediction results, the control unit 1320 may configure a transmission message including the information to be reported, and deliver the transmission message to the transceiver to transmit it to the base station.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving cell prediction configuration information;
generating measurement results by performing measurements on a serving cell and neighbor cell(s) based on signal strength measurement configuration information;
generating a result of predicting a best cell by performing best cell prediction based on the measurement results;
determining a target cell that satisfies a cell change condition based on the measurement results;
identifying whether to change the serving cell of the terminal to the target cell based on the result of predicting the best cell; and
in response to identifying that the serving cell is changed to the target cell, performing a procedure to change the serving cell of the terminal to the target cell.
